(19) United States
(12) Patent Application Publication
(10) Pub. No.: US 2025/0254473 A1
(43) Pub. Date: Aug. 7, 2025

(54) ARTEFACT REJECTION FROM HEARING AID ACCELEROMETER DATA

(71) Applicant: Oticon A/S, Smørum (DK)

(72) Inventors: Tanveer BHUIYAN, Smørum (DK); Torsten Kjær SØRENSEN, Smørum (DK); Nicolai WESTERGREN, Smørum (DK); Morten WESTERGAARD, Smørum (DK); Juan Manuel VÖLKER, Smørum (DK)

(21) Appl. No.: 19/039,800

(22) Filed: Jan. 29, 2025

(30) Foreign Application Priority Data
Feb. 5, 2024 (EP) 24155744.6

(51) Int. Cl. H04R 25/00

(52) U.S. Cl. CPC H04R 25/505

(57) ABSTRACT

Disclosed herein are embodiments of a hearing aid. The hearing aid can include an accelerometer configured for providing accelerometer data with respect to movement and/or orientation on a coordinate system. The hearing aid can be configured to determine motion bias of the hearing aid, as well as estimate a listening intention based on said motion bias. The hearing aid is configured to set one or more signal processing parameters based on the estimated listening intention.

### CROSS REFERENCE TO RELATED APPLICATIONS

Any and all application for which a foreign or domestic priority claim is identified in the Application Data Sheet as filed with the present application are hereby incorporated by reference under 37 CFR 1.57.

### TECHNICAL FIELD

The present application relates to the field of hearing aids.

### SUMMARY

The present application relates to a hearing aid adapted for being located at or in an ear of a user.

The present application further relates to a method.

The present application further relates to a computer program.

### A Hearing Aid:

Sensor members for detecting a movement of a hearing aid user, such as accelerometers, integrated within a hearing aid serve as a valuable tool for translating the hearing aid user's listening intention. Typically, hearing aid users orient their head in the direction of the individual with whom they intend to engage in a conversation and discuss. Consequently, a conversation characterized by focused attention is often associated with minimal or negligible head movement. On the other hand, when the hearing aid user is engaged in conversations with several individuals or in a group of people, the user may find it necessary to adjust his/her head laterally from time to time, either for social reasons or for reading the talker's lips.

Ideally, the above movement pattern can be classified by using the axes or plane data or information collected from the sensor member of the hearing aid. This permits for a more efficient determination of the user's listening intention and focus during conversations.

The user's listening intention can be translated from the collected data or information from the sensor member by quantifying the movements as ‘counts’ in the three different axes. A conversation characterized by a high degree of focus is associated with low or no counts. This, in turn, prompts the Multi-Channel Enhancement (MCE) system to provide enhanced help such as high directionality and noise reduction. On the contrary, lateral head movements result to higher counts in the XY plane which triggers the MCE system to provide default directionality and noise reduction.

In the context of a one-to-one conversation, it is natural for the hearing aid user to do back-channeling through nodding. Nodding, while a form of physical gesture, serves further as an indicator of focused conversation. Even though the hearing aid user gets increased directionality for focused conversation which is characterised primarily by minimum or zero counts (movement), the nodding should also be considered as a gesture of focused conversation involving movement in a plane perpendicular to the lateral movement plane.

Theoretically, if an accelerometer co-ordinate system is aligned to the physical co-ordinate system, where X axis points forward, Y axis to the Left, and Z axis exactly opposite to the gravity, then a lateral head turn will have centrifugal acceleration in the XY plane. Similarly, a nodding gesture will have impact on XZ plane.

However, the hypothesis described above is only partially true due to the placement of the accelerometer. Since the hearing aid is not at the centre of rotation, the two perpendicular movements are not significantly discriminant. For both nodding and lateral head turns, activity in X axis dominates Y and Z often. Therefore, the activity in the X+Y axes is often not very different from in the X+Z axes, which ideally separates nodding from lateral head turn. There is a possibility of misclassifying a nod to be a head turn. Sometimes nodding may trigger the MCE system to get out of focused mode due to the associated movements. Hence, a robust method is required to filter out the nodding, i.e., to keep the hearing aid user in focus mode during nod related ‘artefacts’.

In an aspect of the present application, a hearing aid is provided.

The hearing aid may be adapted to being located at or in an ear of a hearing aid user.

The hearing aid may comprise an input unit for receiving an input sound signal from an acoustic environment of a hearing aid user.

The input unit may be suitable for providing at least one electric input signal representing said input sound signal.

The input unit may comprise an input transducer, e.g. a microphone, for converting an input sound to an electric input signal. The input unit may comprise a wireless receiver for receiving a wireless signal comprising or representing sound and for providing an electric input signal representing said sound.

The hearing aid may comprise an output unit for providing at least one set of stimuli perceivable as sound to the hearing aid user based on processed versions of said at least one electric input signal.

The output unit may comprise a vibrator of a bone conducting hearing aid. The output unit may comprise an output transducer. The output transducer may comprise a receiver (loudspeaker) for providing the stimulus as an acoustic signal to the user (e.g. in an acoustic (air conduction based) hearing aid). The output transducer may comprise a vibrator for providing the stimulus as mechanical vibration of a skull bone to the user (e.g. in a bone-attached or bone-anchored hearing aid). The output unit may (additionally or alternatively) comprise a (e.g. wireless) transmitter for transmitting sound picked up-by the hearing aid to another device, e.g. a far-end communication partner (e.g. via a network, e.g. in a telephone mode of operation, or in a headset configuration).

The hearing aid may comprise a sensor member for detecting a movement of the user.

The hearing aid may comprise a sensor member for detecting an orientation of the user's head.

The sensor member (movement detector) may be configured to detect movement of the user's facial muscles and/or bones, e.g. due to speech or chewing (e.g. jaw movement) and to provide a detector signal indicative thereof.

The sensor member may comprise an accelerometer configured to provide accelerometer data comprising at least one signal representing said movement in X-, Y-, and Z-axes of an X-Y-Z co-ordinate system.

The sensor member may comprise an accelerometer configured to provide accelerometer data comprising at least one signal representing said orientation in X-, Y-, and Z-axes of an X-Y-Z co-ordinate system.

The hearing aid may be configured to translate the accelerometer data to quantify said movement and/or orientation as counts in said X-, Y-, and Z-axes.

The hearing aid may be further configured to separate lateral head movements defined as counts in said X- and Y-axes and vertical head movements defined as counts in the X- and Z-axes.

The hearing aid may further comprise a decision unit configured to determine a motion bias.

The decision unit may be configured to determine said motion bias by calculating at least a sample-by-sample minimum of the counts in said X- and Y-axes.

The decision unit may be configured to estimate a listening intention of the user based on said motion bias.

For example, the decision block may be configured to filter the accelerometer data by calculating at least a sample-by-sample minimum of the counts in said X- and Y-axes.

The decision block may be further configured to estimate a listening intention of the hearing aid user based on said sample-by-sample minimum.

Block may within the application refer to a unit or a module.

Thus, a block may refer to a software module/unit, or may refer to a physical unit/module in the hearing aid.

The hearing aid may further comprise a processing unit.

The hearing aid may be configured to set signal processing parameters of the processing unit based on the estimated listening intention of the user.

In other words, the decision block may be configured to estimate a listening intention of the hearing aid user based on a determined motion bias.

The hearing aid may be configured to determine said motion bias from said sample-by-sample minimum of the counts in said X- and Y-axes.

Thus, in case the motion bias is 1, the decision block may be configured to estimate that the user's listening intention is full focus (e.g., one-to-one conversation). Thereby, the processing unit (or the hearing aid) may be configured to set the signal processing parameters (of the processing unit) to provide an increased level of directionality and/or noise reduction.

Thus, in case the motion bias is 0, the decision block may be configured to estimate that the user's listening intention is not full focus. Thereby, the processing unit (or the hearing aid) may be configured to set the signal processing parameters (of the processing unit) to provide default directionality and/or noise reduction.

Thereby, a more efficient setting of signal processing parameters of the processing unit is provided by the estimated listening intention of the hearing aid user.

The hearing aid may comprise a preprocessing block.

The preprocessing block may be configured to carry out a filtering step of the accelerometer data and alignment of the X-Y-Z co-ordinate system of the accelerometer with a standardized co-ordinate frame by use of a rotation matrix.

The hearing aid may comprise a motion block arranged upstream of said decision block.

The motion block may be configured to carry out a quantification of the accelerometer data to estimate said movement and/or orientation as counts in said X-, Y-, and Z-axes.

The motion block may be configured to carry out said separation of lateral head movements defined as counts in said X- and Y-axes and vertical head movements defined as counts in the X- and Z-axes.

The decision block may comprise a minimum (X, Y) block.

The minimum (X, Y) block may be configured to calculate said sample-by-sample minimum of the counts in said X- and Y-axes.

The decision block may be configured to process said sample-by-sample minimum of the counts in said X- and Y-axes in an Input/Output (I/O) Module.

The decision block may provide an I/O map by the I/O Module.

The decision block may be configured to truncate the counts in the Z-axis.

The decision block may be configured to process said counts in the Z-axis in said I/O Module to provide the I/O map.

The hearing aid may be suitable for filtering out artefacts due to nodding and other back channeling gestures based on said calculation of sample-by-sample minimum of the counts in said X- and Y-axes.

The decision block may be configured to filter out transient movements in the Z-axis.

Thereby, minor or sudden movements will not change the motion bias abruptly. In other words, if a movement is transient and unintended, which may change the motion bias unexpectedly, the movement will be filtered out.

The decision block may be configured to determine a motion bias by estimating said sample-by-sample minimum of counts in said X- and Y-axes and said counts in the Z-axis, respectively, relative to predetermined I/O map thresholds of the hearing aid user, after said sample-by-sample minimum of X and Y counts have been processed in the I/O Module.

The decision block may be configured to calculate a sum of the motion bias for the X-, Y-, and Z-axes of the X-Y-Z co-ordinate system.

The decision block may comprise a mode switch.

The mode switch may be configured to switch between a focused listening mode and a non-focused listening mode.

The mode switch may be configured to classify the listening mode as being in one of the following four categories:
value equal to 0 defined as Motion Bias
value equal to 1 defined as Focused listening mode
value equal to 2 defined as Default listening mode
value equal to 3 defined as Aware listening mode

Accordingly, the mode switch may be configured to switch to the focused listening mode when the motion bias is equal to 1.

Further, the mode switch may be configured to switch to the non-focused listening mode when the motion bias may be equal to 0.

The hearing aid may be configured to set signal processing parameters of the processing unit.

The hearing aid may be configured to set a Multi-Channel Enhancement (MCE) system of the processing unit to provide a higher directionality and noise reduction when the motion bias is equal to 1 than when the motion bias is equal to 0.

The step of the hearing aid setting (and further optimizing) the signal processing parameters may comprise controlling and enhancing beamforming.

The step of the hearing aid setting (and further optimizing) the signal processing parameters may comprise increasing noise reduction, in terms of different noise classification levels, regulating SNR levels, and optimizing directionality by setting and further optimizing the signal processing parameters.

The hearing aid may be adapted to provide a frequency dependent gain and/or a level dependent compression and/or a transposition (with or without frequency compression) of one or more frequency ranges to one or more other frequency ranges, e.g. to compensate for a hearing impairment of a user.

The wireless receiver and/or transmitter may e.g. be configured to receive and/or transmit an electromagnetic signal in the radio frequency range (3 kHz to 300 GHz). The wireless receiver and/or transmitter may e.g. be configured to receive and/or transmit an electromagnetic signal in a frequency range of light (e.g. infrared light 300 GHz to 430 THz, or visible light, e.g. 430 THz to 770 THz).

The hearing aid may comprise a directional microphone system adapted to spatially filter sounds from the environment, and thereby enhance a target acoustic source among a multitude of acoustic sources in the local environment of the user wearing the hearing aid. The directional system may be adapted to detect (such as adaptively detect) from which direction a particular part of the microphone signal originates. This can be achieved in various different ways as e.g. described in the prior art. In hearing aids, a microphone array beamformer is often used for spatially attenuating background noise sources. The beamformer may comprise a linear constraint minimum variance (LCMV) beamformer. Many beamformer variants can be found in literature. The minimum variance distortionless response (MVDR) beamformer is widely used in microphone array signal processing. Ideally the MVDR beamformer keeps the signals from the target direction (also referred to as the look direction) unchanged, while attenuating sound signals from other directions maximally. The generalized sidelobe canceller (GSC) structure is an equivalent representation of the MVDR beamformer offering computational and numerical advantages over a direct implementation in its original form.

Most sound signal sources (except the user's own voice) are located far way from the user compared to dimensions of the hearing aid, e.g. a distance d_{mic} between two microphones of a directional system. A typical microphone distance in a hearing aid is of the order 10 mm. A minimum distance of a sound source of interest to the user (e.g. sound from the user's mouth or sound from an audio delivery device) is of the order of 0.1 m (>10 d_{mic}). For such minimum distances, the hearing aid (microphones) would be in the acoustic near-field of the sound source and a difference in level of the sound signals impinging on respective microphones may be significant. A typical distance for a communication partner is more than 1 m (>100 d_{mic}). The hearing aid (microphones) would be in the acoustic far-field of the sound source and a difference in level of the sound signals impinging on respective microphones is insignificant. The difference in time of arrival of sound impinging in the direction of the microphone axis (e.g. the front or back of a normal hearing aid) is ΔT=d_{mic}/v_{sound}=0.01/343 [s]=29 μs, where v_{sound} is the speed of sound in air at 20° C. (343 m/s).

The hearing aid may comprise antenna and transceiver circuitry allowing a wireless link to an entertainment device (e.g. a TV-set), a communication device (e.g. a telephone), a wireless microphone, a separate (external) processing device, or another hearing aid, etc. The hearing aid may thus be configured to wirelessly receive a direct electric input signal from another device. Likewise, the hearing aid may be configured to wirelessly transmit a direct electric output signal to another device. The direct electric input or output signal may represent or comprise an audio signal and/or a control signal and/or an information signal.

In general, a wireless link established by antenna and transceiver circuitry of the hearing aid can be of any type. The wireless link may be a link based on near-field communication, e.g. an inductive link based on an inductive coupling between antenna coils of transmitter and receiver parts. The wireless link may be based on far-field, electromagnetic radiation. Preferably, frequencies used to establish a communication link between the hearing aid and the other device is below 70 GHz, e.g. located in a range from 50 MHz to 70 GHz, e.g. above 300 MHz, e.g. in an ISM range above 300 MHz, e.g. in the 900 MHz range or in the 2.4 GHz range or in the 5.8 GHz range or in the 60 GHz range (ISM=Industrial, Scientific and Medical, such standardized ranges being e.g. defined by the International Telecommunication Union, ITU). The wireless link may be based on a standardized or proprietary technology. The wireless link may be based on Bluetooth technology (e.g. Bluetooth Low-Energy technology, e.g. LE audio), or Ultra WideBand (UWB) technology.

The hearing aid may be constituted by or form part of a portable (i.e. configured to be wearable) device, e.g. a device comprising a local energy source, e.g. a battery, e.g. a rechargeable battery. The hearing aid may e.g. be a low weight, easily wearable, device, e.g. having a total weight less than 100 g, such as less than 20 g, such as less than 5 g.

The hearing aid may comprise a ‘forward’ (or ‘signal’) path for processing an audio signal between an input and an output of the hearing aid. A signal processor may be located in the forward path. The signal processor may be adapted to provide a frequency dependent gain according to a user's particular needs (e.g. hearing impairment). The hearing aid may comprise an ‘analysis’ path comprising functional components for analyzing signals and/or controlling processing of the forward path. Some or all signal processing of the analysis path and/or the forward path may be conducted in the frequency domain, in which case the hearing aid comprises appropriate analysis and synthesis filter banks. Some or all signal processing of the analysis path and/or the forward path may be conducted in the time domain.

An analogue electric signal representing an acoustic signal may be converted to a digital audio signal in an analogue-to-digital (AD) conversion process, where the analogue signal is sampled with a predefined sampling frequency or rate fₛ, fₛ being e.g. in the range from 8 kHz to 48 kHz (adapted to the particular needs of the application) to provide digital samples xₙ (or x[n]) at discrete points in time tₙ (or n), each audio sample representing the value of the acoustic signal at tₙ by a predefined number N_{b} of bits, N_{b} being e.g. in the range from 1 to 48 bits, e.g. 24 bits. Each audio sample is hence quantized using N_{b} bits (resulting in 2^{Nb} different possible values of the audio sample). A digital sample x has a length in time of 1/fₛ, e.g. 50 μs, for fₛ=20 kHz. A number of audio samples may be arranged in a time frame. A time frame may comprise 64 or 128 audio data samples. Other frame lengths may be used depending on the practical application.

The hearing aid may comprise an analogue-to-digital (AD) converter to digitize an analogue input (e.g. from an input transducer, such as a microphone) with a predefined sampling rate, e.g. 20 kHz. The hearing aids may comprise a digital-to-analogue (DA) converter to convert a digital signal to an analogue output signal, e.g. for being presented to a user via an output transducer.

The hearing aid, e.g. the input unit, and/or the antenna and transceiver circuitry may comprise a transform unit for converting a time domain signal to a signal in the transform domain (e.g. frequency domain or Laplace domain, Z transform, wavelet transform, etc.). The transform unit may be constituted by or comprise a TF-conversion unit for providing a time-frequency representation of an input signal. The time-frequency representation may comprise an array or map of corresponding complex or real values of the signal in question in a particular time and frequency range. The TF conversion unit may comprise a filter bank for filtering a (time varying) input signal and providing a number of (time varying) output signals each comprising a distinct frequency range of the input signal. The TF conversion unit may comprise a Fourier transformation unit (e.g. a Discrete Fourier Transform (DFT) algorithm, or a Short Time Fourier Transform (STFT) algorithm, or similar) for converting a time variant input signal to a (time variant) signal in the (time-) frequency domain. The frequency range considered by the hearing aid from a minimum frequency fₘᵢₙ to a maximum frequency fₘₐₓ may comprise a part of the typical human audible frequency range from 20 Hz to 20 kHz, e.g. a part of the range from 20 Hz to 12 kHz. Typically, a sample rate fₛ is larger than or equal to twice the maximum frequency fₘₐₓ, fₛ≥2fₘₐₓ. A signal of the forward and/or analysis path of the hearing aid may be split into a number NI of frequency bands (e.g. of uniform width), where NI is e.g. larger than 5, such as larger than 10, such as larger than 50, such as larger than 100, such as larger than 500, at least some of which are processed individually. The hearing aid may be adapted to process a signal of the forward and/or analysis path in a number NP of different frequency channels (NP≤NI). The frequency channels may be uniform or non-uniform in width (e.g. increasing in width with frequency), overlapping or non-overlapping.

The hearing aid may be configured to operate in different modes, e.g. a normal mode and one or more specific modes, e.g. selectable by a user, or automatically selectable. A mode of operation may be optimized to a specific acoustic situation or environment, e.g. a communication mode, such as a telephone mode. A mode of operation may include a low-power mode, where functionality of the hearing aid is reduced (e.g. to save power), e.g. to disable wireless communication, and/or to disable specific features of the hearing aid.

The hearing aid may comprise a number of detectors configured to provide status signals relating to a current physical environment of the hearing aid (e.g. the current acoustic environment), and/or to a current state of the user wearing the hearing aid, and/or to a current state or mode of operation of the hearing aid. Alternatively, or additionally, one or more detectors may form part of an external device in communication (e.g. wirelessly) with the hearing aid. An external device may e.g. comprise another hearing aid, a remote control, and audio delivery device, a telephone (e.g. a smartphone), an external sensor, etc.

One or more of the number of detectors may operate on the full band signal (time domain). One or more of the number of detectors may operate on band split signals ((time-)frequency domain), e.g. in a limited number of frequency bands.

The number of detectors may comprise a level detector for estimating a current level of a signal of the forward path. The detector may be configured to decide whether the current level of a signal of the forward path is above or below a given (L-)threshold value. The level detector operates on the full band signal (time domain). The level detector operates on band split signals ((time-) frequency domain).

The hearing aid may comprise a voice activity detector (VAD) for estimating whether or not (or with what probability) an input signal comprises a voice signal (at a given point in time). A voice signal may in the present context be taken to include a speech signal from a human being. It may also include other forms of utterances generated by the human speech system (e.g. singing). The voice activity detector unit may be adapted to classify a current acoustic environment of the user as a VOICE or NO-VOICE environment. This has the advantage that time segments of the electric microphone signal comprising human utterances (e.g. speech) in the user's environment can be identified, and thus separated from time segments only (or mainly) comprising other sound sources (e.g. artificially generated noise). The voice activity detector may be adapted to detect as a VOICE also the user's own voice. Alternatively, the voice activity detector may be adapted to exclude a user's own voice from the detection of a VOICE.

The hearing aid may comprise an own voice detector for estimating whether or not (or with what probability) a given input sound (e.g. a voice, e.g. speech) originates from the voice of the user of the system. A microphone system of the hearing aid may be adapted to be able to differentiate between a user's own voice and another person's voice and possibly from NON-voice sounds.

The hearing aid may comprise a classification unit configured to classify the current situation based on input signals from (at least some of) the detectors/sensors, and possibly other inputs as well. In the present context ‘a current situation’ may be taken to be defined by one or more of
a) the physical environment (e.g. including the current electromagnetic environment, e.g. the occurrence of electromagnetic signals (e.g. comprising audio and/or control signals) intended or not intended for reception by the hearing aid, or other properties of the current environment than acoustic);
b) the current acoustic situation (input level, feedback, etc.), and
c) the current mode or state of the user (movement, temperature, cognitive load, etc.);
d) the current mode or state of the hearing aid (program selected, time elapsed since last user interaction, etc.) and/or of another device in communication with the hearing aid.

The classification unit may be based on or comprise a neural network, e.g. a recurrent neural network, e.g. a trained neural network.

The hearing aid may comprise an acoustic (and/or mechanical) feedback control (e.g. suppression) or echo-cancelling system. Adaptive feedback cancellation has the ability to track feedback path changes over time. It is typically based on a linear time invariant filter to estimate the feedback path, but its filter weights are updated over time. The filter update may be calculated using stochastic gradient algorithms, including some form of the Least Mean Square (LMS) or the Normalized LMS (NLMS) algorithms. They both have the property to minimize the error signal in the mean square sense with the NLMS additionally normalizing the filter update with respect to the squared Euclidean norm of some reference signal.

The hearing aid may further comprise other relevant functionality for the application in question, e.g. compression, noise reduction, etc.

The hearing aid may comprise a hearing instrument, e.g. a hearing instrument adapted for being located at the ear or fully or partially in the ear canal of a user, e.g. a headset, an earphone, an ear protection device or a combination thereof. A hearing system may comprise a speakerphone (comprising a number of input transducers (e.g. a microphone array) and a number of output transducers, e.g. one or more loudspeakers, and one or more audio (and possibly video) transmitters e.g. for use in an audio conference situation), e.g. comprising a beamformer filtering unit, e.g. providing multiple beamforming capabilities.

### Use:

In an aspect, use of a hearing aid system and a hearing aid as described above, in the detailed description of embodiments' and in the claims, is moreover provided. Use may be provided in a hearing aid system comprising one or more hearing aids (e.g. hearing instruments), headsets, earphones, active ear protection systems, etc., e.g. in handsfree telephone systems, teleconferencing systems (e.g. including a speakerphone), public address systems, karaoke systems, classroom amplification systems, etc.

### A Method:

In an aspect of the present application, a method is provided.

The method may comprise receiving an input sound signal from an acoustic environment of a hearing aid user.

The method may comprise providing at least one electric input signal representing said input sound signal.

The method may comprise providing at least one set of stimuli perceivable as sound to the hearing aid user based on processed versions of said at least one electric input signal.

The method may comprise detecting a movement of the user.

The method may comprise detecting an orientation of the user's head.

The method may comprise providing accelerometer data comprising at least one signal representing said movement and/or orientation in X-, Y-, and Z-axes of an X-Y-Z co-ordinate system.

The method may comprise translating the accelerometer data to quantify said movement and/or orientation as counts in said X-, Y-, and Z-axes.

The method may comprise separating lateral head movements defined as counts in said X- and Y-axes and vertical head movements defined as counts in said X- and Z-axes.

The method may comprise determining a motion bias.

The motion bias may be determined by calculating at least a sample-by-sample minimum of the counts in said X- and Y-axes.

The method may comprise estimating a listening intention of the (hearing aid) user based on said motion bias.

For example, the method may comprise filtering the accelerometer data by calculating at least a sample-by-sample minimum of the counts in said X- and Y-axes.

For example, the method may comprise estimating a listening intention of the user based on said sample-by-sample minimum.

The hearing aid may comprise setting signal processing parameters of a processing unit based on the estimated listening intention of the hearing aid user.

It is intended that some or all of the structural features of the hearing aid described above, in the ‘detailed description of embodiments’ or in the claims can be combined with embodiments of the method, when appropriately substituted by a corresponding process and vice versa. Embodiments of the method have the same advantages as the corresponding hearing aid.

### A Computer Readable Medium or Data Carrier:

In an aspect, a tangible computer-readable medium (a data carrier) storing a computer program comprising program code means (instructions) for causing a data processing system (a computer) to perform (carry out) at least some (such as a majority or all) of the (steps of the) method described above, in the ‘detailed description of embodiments’ and in the claims, when said computer program is executed on the data processing system is furthermore provided by the present application.

By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Other storage media include storage in DNA (e.g. in synthesized DNA strands). Combinations of the above should also be included within the scope of computer-readable media. In addition to being stored on a tangible medium, the computer program can also be transmitted via a transmission medium such as a wired or wireless link or a network, e.g. the Internet, and loaded into a data processing system for being executed at a location different from that of the tangible medium.

### A Computer Program:

A computer program (product) comprising instructions which, when the program is executed by a computer, cause the computer to carry out (steps of) the method described above, in the ‘detailed description of embodiments’ and in the claims is furthermore provided by the present application.

In an aspect, a computer program comprising instructions which, when the program is executed by a processor unit of a hearing aid as described above is furthermore provided by the present application.

The computer program may cause the hearing aid to perform at least translating the accelerometer data to quantify said movement and/or orientation as counts in said X-, Y-, and Z-axes.

The computer program may cause the hearing aid to perform at least separating lateral head movements defined as counts in said X- and Y-axes and other head movements defined as counts in the Z-axis.

The computer program may cause the hearing aid to perform at least filtering the accelerometer data by calculating at least a sample-by-sample minimum of the counts in said X- and Y-axes.

The computer program may cause the hearing aid to perform at least estimating a listening intention of the user based on said sample-by-sample minimum.

The computer program may cause the hearing aid to perform at least setting signal processing parameters based on the estimated listening intention of the user.

### A Data Processing System:

In an aspect, a data processing system comprising a processor and program code means for causing the processor to perform at least some (such as a majority or all) of the steps of the method described above, in the ‘detailed description of embodiments’ and in the claims is furthermore provided by the present application.

### A Hearing System:

In a further aspect, a hearing system comprising a hearing aid as described above, in the ‘detailed description of embodiments’, and in the claims, AND an auxiliary device is moreover provided.

The hearing system may be adapted to establish a communication link between the hearing aid and the auxiliary device to provide that information (e.g. control and status signals, possibly audio signals) can be exchanged or forwarded from one to the other.

The auxiliary device may be constituted by or comprise a remote control, a smartphone, or other portable or wearable electronic device, such as a smartwatch or the like.

The auxiliary device may be constituted by or comprise a remote control for controlling functionality and operation of the hearing aid(s). The function of a remote control may be implemented in a smartphone, the smartphone possibly running an APP allowing to control the functionality of the audio processing device via the smartphone (the hearing aid(s) comprising an appropriate wireless interface to the smartphone, e.g. based on Bluetooth or some other standardized or proprietary scheme).

The auxiliary device may be constituted by or comprise an audio gateway device adapted for receiving a multitude of audio signals (e.g. from an entertainment device, e.g. a TV or a music player, a telephone apparatus, e.g. a mobile telephone or a computer, e.g. a PC, a wireless microphone, etc.) and adapted for selecting and/or combining an appropriate one of the received audio signals (or combination of signals) for transmission to the hearing aid.

The auxiliary device may be constituted by or comprise another hearing aid. The hearing system may comprise two hearing aids adapted to implement a binaural hearing system, e.g.

a binaural hearing aid system.

### An APP:

In a further aspect, a non-transitory application, termed an APP, is furthermore provided by the present disclosure. The APP comprises executable instructions configured to be executed on an auxiliary device to implement a user interface for a hearing aid or a hearing system described above in the ‘detailed description of embodiments’, and in the claims. The APP may be configured to run on cellular phone, e.g. a smartphone, or on another portable device allowing communication with said hearing aid or said hearing system.

### Definitions

In the present context, a hearing aid, e.g. a hearing instrument, refers to a device, which is adapted to improve, augment and/or protect the hearing capability of a user by receiving acoustic signals from the user's surroundings, generating corresponding audio signals, possibly modifying the audio signals and providing the possibly modified audio signals as audible signals to at least one of the user's ears. Such audible signals may e.g. be provided in the form of acoustic signals radiated into the user's outer ears, acoustic signals transferred as mechanical vibrations to the user's inner ears through the bone structure of the user's head and/or through parts of the middle ear as well as electric signals transferred directly or indirectly to the cochlear nerve of the user.

The hearing aid may be configured to be worn in any known way, e.g. as a unit arranged behind the ear with a tube leading radiated acoustic signals into the ear canal or with an output transducer, e.g. a loudspeaker, arranged close to or in the ear canal, as a unit entirely or partly arranged in the pinna and/or in the ear canal, as a unit, e.g. a vibrator, attached to a fixture implanted into the skull bone, as an attachable, or entirely or partly implanted, unit, etc. The hearing aid may comprise a single unit or several units communicating (e.g. acoustically, electrically or optically) with each other. The loudspeaker may be arranged in a housing together with other components of the hearing aid, or may be an external unit in itself (possibly in combination with a flexible guiding element, e.g. a dome-like element).

A hearing aid may be adapted to a particular user's needs, e.g. a hearing impairment. A configurable signal processing circuit of the hearing aid may be adapted to apply a frequency and level dependent compressive amplification of an input signal. A customized frequency and level dependent gain (amplification or compression) may be determined in a fitting process by a fitting system based on a user's hearing data, e.g. an audiogram, using a fitting rationale (e.g. adapted to speech). The frequency and level dependent gain may e.g. be embodied in processing parameters, e.g. uploaded to the hearing aid via an interface to a programming device (fitting system), and used by a processing algorithm executed by the configurable signal processing circuit of the hearing aid.

A ‘hearing system’ refers to a system comprising one or two hearing aids, and a ‘binaural hearing system’ refers to a system comprising two hearing aids and being adapted to cooperatively provide audible signals to both of the user's ears. Hearing systems or binaural hearing systems may further comprise one or more ‘auxiliary devices’, which communicate with the hearing aid(s) and affect and/or benefit from the function of the hearing aid(s). Such auxiliary devices may include at least one of a remote control, a remote microphone, an audio gateway device, an entertainment device, e.g. a music player, a wireless communication device, e.g. a mobile phone (such as a smartphone) or a tablet or another device, e.g. comprising a graphical interface. Hearing aids, hearing systems or binaural hearing systems may e.g. be used for compensating for a hearing-impaired person's loss of hearing capability, augmenting or protecting a normal-hearing person's hearing capability and/or conveying electronic audio signals to a person. Hearing aids or hearing systems may e.g. form part of or interact with public-address systems, active ear protection systems, handsfree telephone systems, car audio systems, entertainment (e.g. TV, music playing or karaoke) systems, teleconferencing systems, classroom amplification systems, etc.

The invention is set out in the appended set of claims.

### BRIEF DESCRIPTION OF DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIG. 1A shows an example of a presentation of an accelerometer coordinate system according to the present disclosure.

FIG. 1B shows an example of four different motions of the hearing aid user.

FIG. 2 shows an example of a correlation of counts in the X- and Y-axes during lateral and vertical head movements.

FIG. 3 shows an example of a block diagram for estimation of listening intention of a hearing aid user.

FIG. 4 shows an example of a determination of motion bias.

The figures are schematic and simplified for clarity, and they just show details which are essential to the understanding of the disclosure, while other details are left out. Throughout, the same reference signs are used for identical or corresponding parts.

Further scope of applicability of the present disclosure will become apparent from the detailed description given hereinafter. However, it should be understood that the detailed description and specific examples, while indicating preferred embodiments of the disclosure, are given by way of illustration only. Other embodiments may become apparent to those skilled in the art from the following detailed description.

### DETAILED DESCRIPTION OF EMBODIMENTS

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the apparatus and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

The electronic hardware may include micro-electronic-mechanical systems (MEMS), integrated circuits (e.g. application specific), microprocessors, microcontrollers, digital signal processors (DSPs), field programmable gate arrays (FPGAs), programmable logic devices (PLDs), gated logic, discrete hardware circuits, printed circuit boards (PCB) (e.g. flexible PCBs), and other suitable hardware configured to perform the various functionality described throughout this disclosure, e.g. sensors, e.g. for sensing and/or registering physical properties of the environment, the device, the user, etc. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The present application relates to the field of hearing aids.

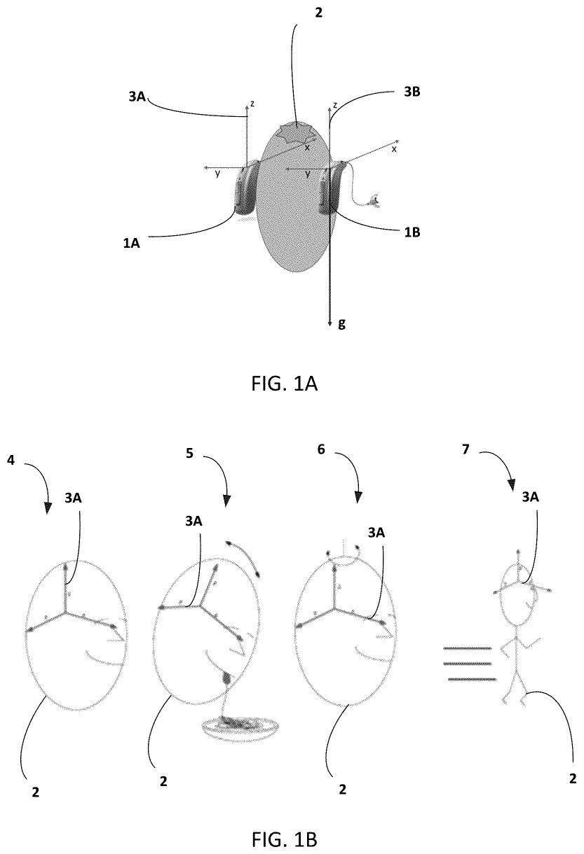

FIG. 1A shows an example of a presentation of an accelerometer coordinate system according to the present disclosure.

In FIG. 1A, a first 1A and a second hearing aid 1B are located at or in an ear of a hearing aid user. Each of the first 1A and second hearing aid 1B comprises a sensor member, which is exemplified as an accelerometer. The hearing aids 2A, 2B are shown to be BTE devices, but other hearing aid types are foreseen. The accelerometers of the hearing aids 1A, 1B are configured to provide accelerometer data comprising at least one signal representing movement and/or orientation in X-, Y-, and Z-axes of an X-Y-Z co-ordinate system. The coordinate systems 3A, 3B for the first 1A and second hearing aids 1B, respectively, are shown. Said coordinate systems 3A, 3B may be aligned to the physical co-ordinate system, in which the Z-axis is aligned with gravity g.

FIG. 1B shows an example of four different motions of the hearing aid user.

In FIG. 1B, the coordinate system 3A for one of the hearing aids of the hearing aid user 2 is shown.

In the first case of motion 4, the hearing aid user 2 is sitting still for which reason no motion is detected by the accelerometer in said X-, Y-, and Z-axes of the X-Y-Z co-ordinate system 3A.

In the second case of motion 5, the hearing aid user 2 is eating and nodding for which reason vertical head movements are detected by the accelerometer in said X- and Z-axes of the X-Y-Z co-ordinate system 3A.

In the third case of motion 6, the hearing aid user 2 turns his/her head for which reason lateral head movements are detected by the accelerometer in said X- and Y-axes of the X-Y-Z co-ordinate system 3A.

In the fourth case of motion 7, the hearing aid user 2 is running or walking for which reason vertical movements are detected by the accelerometer in said Z-axis of the X-Y-Z co-ordinate system 3A.

Since the hearing aid is not at the center of rotation, the two perpendicular movements are not significantly discriminant. For both nodding and lateral head turns, activity in X axis dominates Y and Z often. Therefore, the activity in the X+Y axes is often not very different from activity in the X+Z axes which ideally separates nodding from lateral head turn. Hence, there is a possibility of misclassifying a nod to be a head turn. Therefore, nodding may sometimes trigger e.g. the hearing aid getting out of focused mode.

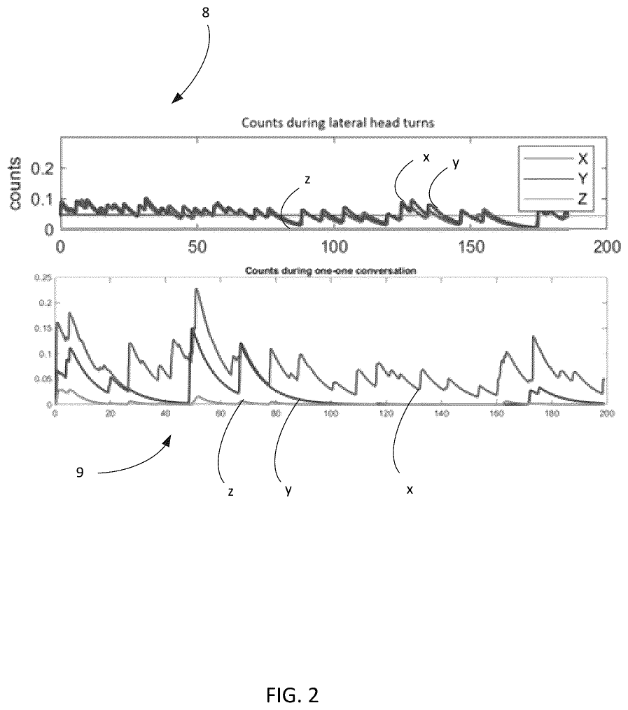

FIG. 2 shows an example of a correlation of counts in the X- and Y-axes during lateral and vertical head movements.

In FIG. 2, the coordinate system of the accelerometer aligned with the physical co-ordinate system. Therefore, one can distinguish the lateral head turn and e.g., vertical gestures by the correlation property of counts (unit of movement measured from the accelerometer) in the X and Y axis.

In the upper graph 8, it is illustrated that the lateral head movements defined as counts in said X- (marked with red) and Y-axes (marked with blue) are highly correlated, while counts in said Z-axis (marked with green) are close to zero.

The lower graph 9, relates to a one-to-one conversation listening scenario which involves a lot of nodding and roll gestures. As shown, the counts in said X- and Y-axes are less correlated. Like the upper graph 8, counts in said Z-axis are close to zero.

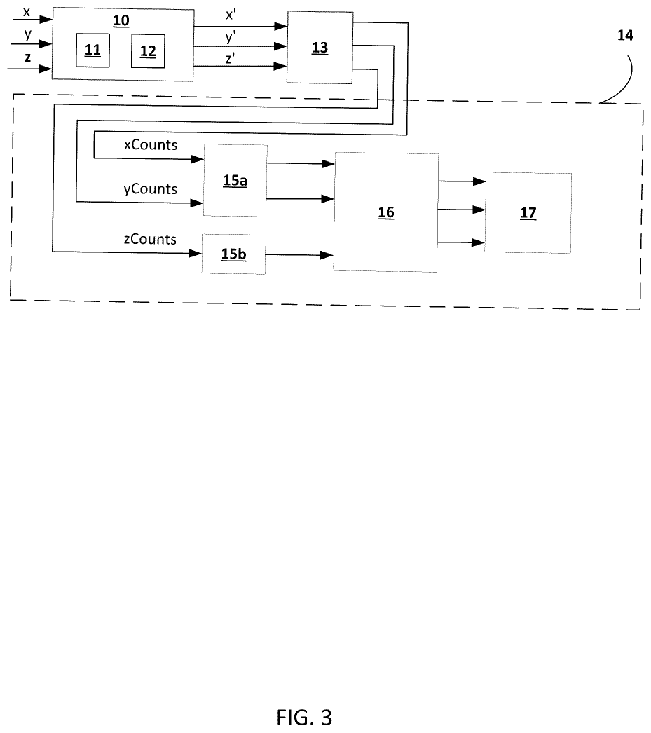

FIG. 3 shows an example of a block diagram for estimation of listening intention of a hearing aid user.

To reduce the computational load, the accelerometer data comprising at least one signal representing said movement and/or orientation in X-, Y-, and Z-axes may be preprocessed.

A preprocessing block 10 may receive said accelerometer data X, Y, and Z. In the preprocessing block 10, the accelerometer data may be filtered in a low-pass filter 11. The filtered accelerometer data may be aligned with a standardized co-ordinate frame by use of a rotation matrix 12.

A motion block 13 may receive the filtered and aligned accelerometer data X′, Y′, and Z′. In the motion block 13, non-body movements may be filtered out.

In other words, the motion block 13 may carry out a quantification of the accelerometer data to estimate said movement and/or orientation as counts in said X-, Y-, and Z-axes, and said separation of lateral head movements defined as counts in said X- and Y-axes and vertical head movements defined as counts in the X- and Z-axes.

The output counts in said X-, Y-, and Z-axes may be sent to a decision block 14. In the decision block 14, counts in the X- and Y-axes are introduced into a minimum (X, Y) block 15a. The minimum (X, Y) block 15a may be configured to calculate a sample-by-sample minimum of the counts in said X- and Y-axes. The step of determining the minimum does not significantly reduce the amplitude. Therefore, the energy of minimum (X, Y) is representative of the counts in said X- and Y-axes.

The decision block 14 of the hearing aid may also comprise a truncate Z-axis block 15b configured to truncate the counts in the Z-axis.

The sample-by-sample minimum of the counts in said X- and Y-axes, and the truncated counts in the Z-axis are received by and processed in an Input/Output (I/O) Module 16 to provide an I/O map.

Optionally, a bias hold block 17 may be configured to filter out small movements in the Z-axis. Thereby, transient and unintended movements, which may change the motion bias unexpectedly, may be filtered out.

Therefore, the decision block 14 is configured to determine a motion bias by estimating said sample-by-sample minimum of counts in said X- and Y-axes and said counts in the Z-axis, respectively, relative to predetermined I/O map thresholds of the hearing aid user, after said sample-by-sample minimum of X and Y counts have been processed in the I/O Module.

In other words, the decision block 14 may be configured to estimate a listening intention of the user based on the determined motion bias.

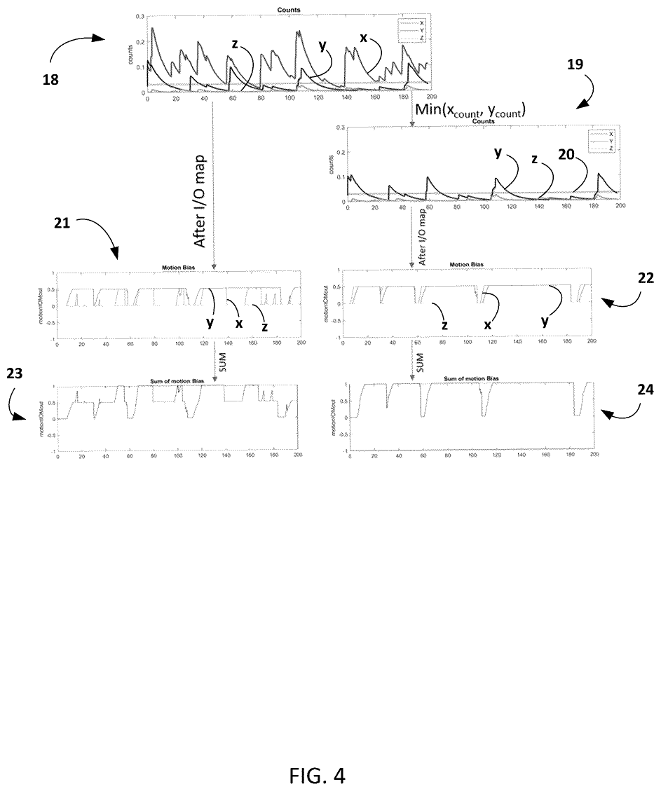

FIG. 4 shows an example of determination of motion bias.

The left and right panels show the processing of X- and Y-counts (see top graph 18) measured by an accelerometer, e.g. during a one-to-one conversation involving nodding, without and with minimum operation in a minimum (X, Y) block (e.g., 15a in FIG. 3), respectively. Thus, in the right panels (19; 22; 24), the X- and Y-counts 18 are processed in the minimum (X, Y) block providing a graph 19 showing minimum of the X- and Y-counts. The minimum of the X- and Y-counts essentially result in the Y-counts.

In the left panels (21; 23), the X- and Y-counts 18 are not processed in the minimum (X, Y) block.

After the minimum operation in the minimum (X, Y) block, the X- and Y-counts are fed into an I/O map (e.g., generated by the I/O Module 16 in FIG. 3) to generate motion bias related to the counts of the individual axes. The X- and Y-counts are converted to motion bias based on the I/O map thresholds (horizontal line 20 on the count plots)

In the left panel, a graph 21 showing the motion bias after generating the I/O map, but without determining the minimum X- and Y-counts is shown.

In the right panel, a graph 22 showing the motion bias after generating the I/O map and with the determination of the minimum X- and Y-counts is shown.

In the bottom of the two panels, graphs 23, 24 showing the calculated total motion bias (i.e., the sum of motion bias in all three axes) are seen. A motion bias of 1 means that the hearing aid user has full focus, while a motion bias of 0 means that the hearing aid user does not have full focus in the one-to-one conversation, for which reason default MCE is applied.

In other words, the decision block 14 may be configured to estimate a listening intention of the user based on the determined motion bias.

Thus, in case the motion bias is 1, the decision unit 14 may be configured to estimate that the user's listening intention is full focus (e.g., one-to-one conversation). Thereby, the processing unit (or the hearing aid) may be configured to set the signal processing parameters (of the processing unit) to provide an increased level of directionality and/or noise reduction.

Thus, in case the motion bias is 0, the decision unit 14 may be configured to estimate that the user's listening intention is not full focus. Thereby, the processing unit (or the hearing aid) may be configured to set the signal processing parameters (of the processing unit) to provide default directionality and/or noise reduction.

It is expected that if the hearing aid user is having a focused one-to-one conversation, he/she should be in full focus mode (motion bias 1). However, from the left bottom graph 23, it is seen that the motion bias is transitioning between 0 and 1 due to the X-counts. This is unexpected behaviour.

It is seen that the motion bias is more stable in the right bottom graph 24 than in the left bottom graph 23, thereby remaining more in focused mode. Accordingly, by taking the minimum of X- and Y-counts, artefacts due to nodding and other back channeling gestures have been successfully filtered out.

In other words, the left bottom graph 23 shows the hearing aid user in focused mode 26% out of 3 minutes of conversation, while the bottom right graph 24 shows the hearing aid user in focused mode almost 78% of the duration of the conversation.

It is intended that the structural features of the aids/devices described above, either in the detailed description and/or in the claims, may be combined with steps of the method, when appropriately substituted by a corresponding process.

As used, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element, but an intervening element may also be present, unless expressly stated otherwise. Furthermore, “connected” or “coupled” as used herein may include wirelessly connected or coupled. As used herein, the term “and/or” includes any and all combinations of one or more of the associated listed items. The steps of any disclosed method are not limited to the exact order stated herein, unless expressly stated otherwise.

It should be appreciated that reference throughout this specification to “one embodiment” or “an embodiment” or “an aspect” or features included as “may” means that a particular feature, structure or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art.

The claims are not intended to be limited to the aspects shown herein but are to be accorded the full scope consistent with the language of the claims, wherein reference to an element in the singular is not intended to mean “one and only one” unless specifically so stated, but rather “one or more.” Unless specifically stated otherwise, the term “some” refers to one or more.

1. Hearing aid adapted for being located at or in an ear of a user, the hearing aid comprising:
a sensor for detecting a movement of the user and/or an orientation of the user's head,
wherein the sensor comprises an accelerometer configured to provide accelerometer data comprising at least one signal representing said movement and/or orientation in X-, Y-, and Z-axes of an X-Y-Z co-ordinate system,
wherein the hearing aid is configured to translate the accelerometer data to quantify said movement and/or orientation as counts in said X-, Y-, and Z-axes and to separate lateral head movements defined as counts in said X- and Y-axes and vertical head movements defined as counts in the X- and Z-axes, and
wherein the hearing aid is configured to determine a motion bias by calculating at least a sample-by-sample minimum of the counts in said X- and Y-axes, and configured to estimate a listening intention of the user based on said motion bias, and
wherein the hearing aid comprises a processor, and where the hearing aid is configured to set signal processing parameters of the processor based on the estimated listening intention of the user.

2. Hearing aid according to claim 1, wherein the hearing aid comprises a preprocessor configured to carry out a filtering step of the accelerometer data and alignment of the X-Y-Z co-ordinate system of the accelerometer with a standardized co-ordinate frame by use of a rotation matrix.

3. Hearing aid according to claim 1, wherein the hearing aid is configured to carry out said quantification of the accelerometer data to estimate said movement and/or orientation as counts in said X-, Y-, and Z-axes and said separation of lateral head movements defined as counts in said X- and Y-axes and vertical head movements defined as counts in the X- and Z-axes.

4. Hearing aid according to claim 1, wherein the hearing aid is configured to calculate said sample-by-sample minimum of the counts in said X- and Y-axes.

5. Hearing aid according to claim 1, wherein the hearing aid is configured to process said sample-by-sample minimum of the counts in said X- and Y-axes and provide an Input/Output (I/O) map.

6. Hearing aid according to claim 5, wherein the hearing aid is configured to truncate the counts in the Z-axis and to process said counts to provide the I/O map.

7. Hearing aid according to claim 1, wherein the hearing aid is suitable for filtering out artefacts due to nodding and other back channeling gestures based on said calculation of sample-by-sample minimum of the counts in said X- and Y-axes.

8. Hearing aid according to claim 1, wherein the hearing aid is configured to filter out transient movements in the Z-axis.

9. Hearing aid according to claim 5, wherein the hearing aid is configured to determine said motion bias by estimating said sample-by-sample minimum of counts in said X- and Y-axes and said counts in the Z-axis, respectively, relative to predetermined I/O map thresholds of the hearing aid user, after said sample-by-sample minimum of X and Y counts have been processed.

10. Hearing aid according to claim 9, wherein the hearing aid is configured to calculate a sum of the motion bias for the X-, Y-, and Z-axes of the X-Y-Z co-ordinate system.

11. Hearing aid according to claim 1, wherein the hearing aid comprises a mode switch and where the mode switch is configured to switch between a focused listening mode and a non-focused listening mode.

12. Hearing aid according to claim 9, wherein the hearing aid is configured to set signal processing parameters, in particular to set a Multi-Channel Enhancement (MCE) system of the processing unit to provide a higher directionality and noise reduction when the motion bias is equal to 1 than when the motion bias equal to 0.

13. Hearing aid according to claim 1, wherein setting and further optimizing the signal processing parameters comprises controlling and enhancing beamforming, increasing noise reduction, in terms of different noise classification levels, regulating SNR levels, and optimizing directionality.

14. A method comprising of
detecting a movement of the user and/or an orientation of the user's head,
providing accelerometer data comprising at least one signal representing said movement and/or orientation in X-, Y-, and Z-axes of an X-Y-Z co-ordinate system,
translating the accelerometer data to quantify said movement and/or orientation as counts in said X-, Y-, and Z-axes,
separating lateral head movements defined as counts in said X- and Y-axes and vertical head movements defined as counts in said X- and Z-axes,
determining a motion bias by calculating at least a sample-by-sample minimum of the counts in said X- and Y-axes,
estimating a listening intention of the user based on said motion bias, and
setting signal processing parameters based on the estimated listening intention of the user.

15. Computer program comprising instructions which, when the program is executed by a processor of a hearing aid according to claim 1, cause the hearing aid to perform at least the steps of:
translating the accelerometer data to quantify said movement and/or orientation as counts in said X-, Y-, and Z-axes,
separating lateral head movements defined as counts in said X- and Y-axes and other head movements defined as counts in the Z-axis,
determining a motion bias by calculating at least a sample-by-sample minimum of the counts in said X- and Y-axes,
estimating a listening intention of the user based on said motion bias, and
setting signal processing parameters based on the estimated listening intention of the user.
